(19) United States
(12) Patent Application Publication
(10) Pub. No.: US 2026/0213683 A1
(43) Pub. Date: Jul. 23, 2026

(54) CONTROL DEVICE AND ACTUATOR SYSTEM

(71) Applicant: ROHM CO., LTD., Kyoto-shi (JP)

(72) Inventors: Takahiro NISHIYAMA, Kyoto-shi (JP); Pan YANG, Kyoto-shi (JP)

(21) Appl. No.: 19/451,548

(22) Filed: Jan. 16, 2026

(30) Foreign Application Priority Data
Jan. 17, 2025 (JP) 2025-006761

(51) Int. Cl. H02P 21/00

(52) U.S. Cl. CPC H02P 21/0014

(57) ABSTRACT

The control device includes a control block configured to generate, on a basis of feedback signals derived from an actuator, control output signals intended for control of the actuator, and an anomaly detection block configured to detect an anomaly on a basis of intermediate arithmetic data which are generated by computation in a generation process of the control output signals according to the feedback signals in the control block.

### CROSS REFERENCE TO RELATED APPLICATIONS

The present invention claims priority under 35 U.S.C. § 119 to Patent Application No 2025-006761 filed in Japan on Jan. 17, 2025, the entire contents of which are hereby incorporated by reference.

### BACKGROUND OF THE INVENTION

### Field of the Invention

The present disclosure relates to a control device.

### Description of the Related Art

Conventionally, in systems using an actuator such as motors, it is common practice to provide a control device operable to control the actuator.

For example, International Publication WO 2021/200671 discloses a motor control device in which a machine learning block detects fault levels on a basis of data detected by a vibration sensor installed on a motor.

### DESCRIPTION OF THE DRAWINGS

FIG. 1 is a diagram showing a schematic configuration of a motor system according to a comparative example.

FIG. 2 is a diagram showing a configuration of a motor system according to an embodiment of the present disclosure,

FIG. 3 is a diagram showing a configuration example of a control block.

FIG. 4 is a diagram showing a configuration example of an anomaly detection block.

FIG. 5 is a diagram showing a configuration of a three-layer neural network.

FIG. 6 is a flowchart showing an example of training process operation in the anomaly detection block.

FIG. 7 is a flowchart showing an example of prediction process operation in the anomaly detection block.

FIG. 8 is a diagram schematically showing examples of FFT process results of an axial error Δθ under comparisons between normal state and anomaly state.

FIG. 9 is a diagram schematically showing examples of FFT process results of a drive current Iu under comparisons between normal state and anomaly state.

### DESCRIPTION OF THE PREFERRED EMBODIMENTS

Hereinbelow, an exemplary embodiment of the present disclosure will be described with reference to accompanying drawings. In the following description, although a motor is treated as a control target as an example, yet an actuator other than motors may instead be treated as the control target.

### Comparative Example

Before proceeding to description of the embodiment of the disclosure, a comparative example of the disclosure will be described for contrast's sake. This treatment allows technical issues to be clarified.

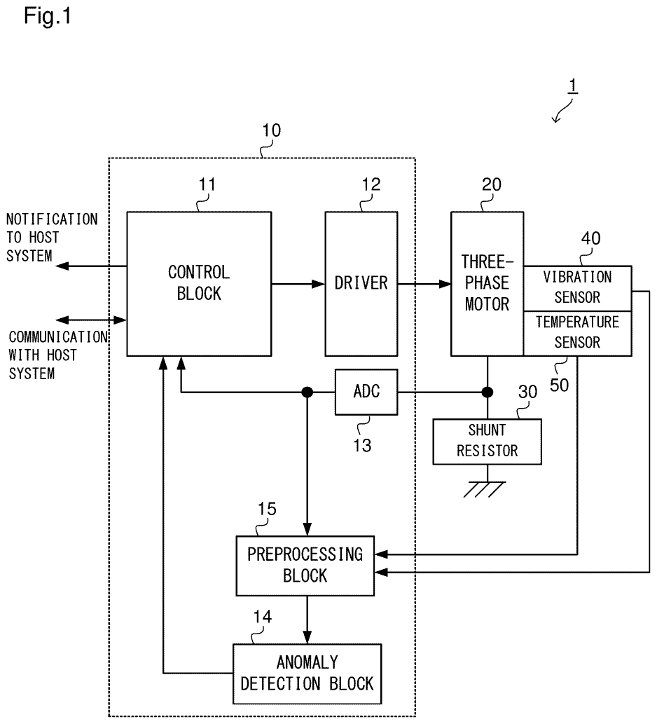

FIG. 1 is a diagram showing a schematic configuration of a motor system 1 according to the comparative example. The motor system 1 shown in FIG. 1 includes a motor control device 10, a three-phase motor 20, a shunt resistor 30, a vibration sensor 40, and a temperature sensor 50. In addition, the motor system is one type of actuator system.

The motor control device 10 is a semiconductor integrated circuit device (so-called motor control IC) which supplies the three-phase motor 20 with three-phase drive currents Iu, Iv and Iw as well as three-phase drive voltages U, V and W to control rotational drive of the three-phase motor 20.

The three-phase motor 20 includes three-phase coils connected to the motor control device 10, and a rotor which rotates in response to the drive currents Iu, Iv and Iw flowing in the foregoing components (neither the coils nor the rotor is shown) In addition, the lower the frequencies of the drive currents Iu, Iv and Iw, the lower the rotational speed (angular velocity) of the rotor, the higher the frequencies of the drive currents Iu, Iv and Iw, the higher the rotational speed (angular velocity) of the rotor.

The shunt resistor 30 generates current sense signals responsive to current values of the drive currents Iu, Iv and Iw, respectively. Although the shunt resistor 30 is connected, in the figure, to the three-phase motor 20 as an example for explanation's sake, yet the shunt resistor 30 may instead be connected to a later-described driver 12. Still, as a current sensing system, a 3-shunt system capable of sensing the drive currents Iu, Iv and Iw, individually, may be adopted, and moreover a 1-shunt system capable of sensing the drive currents Iu, Iv and Iw from a DC bus current of the driver 12 may also be adopted.

The vibration sensor 40 is installed, for example, on the three-phase motor 20 (or at any site on the motor system 1) to detect vibrations of the three-phase motor 20 (or motor system 1). As the vibration sensor 40, for example, an acceleration sensor or a gyrosensor may preferably be used.

The temperature sensor 50 is installed, for example, on the three-phase motor 20 (or at any site on the motor system 1) to detect a temperature of the three-phase motor 20 (or motor system 1).

Still with reference to FIG. 1, configuration and operation of the motor control device 10 will now be explained in detail. The motor control device 10 of this configuration example includes a control block 11, a driver 12, an ADC (Analog-to-Digital Converter) 13, an anomaly detection block 14, and a preprocessing block 15.

The control block 11 accepts input of digital current values (equivalent to current values of the drive currents Iu, lv and Iw, respectively) from the ADC 13. The control block 11 then drives the driver 12 to fulfill feedback control of the drive currents Iu, Iv and Iw flowing in the three-phase motor 20, so that torque and rotational speed of the three-phase motor 20 become equal to target values, respectively.

Also, the control block 11 is equipped with a function of dynamically switching its control parameters or control method in response to a detection result of the anomaly detection block 14, a function of notifying a host system of the above-mentioned detection result, and a function of performing communications with the host system.

The driver 12, including a three-phase half bridge (three-phase upper FET and lower FET) connected to the control block 11, generates three-phase drive currents Iu, Iv and Iw flowing in the three-phase motor 20 on a basis of three-phase gate signals (upper gate signals applied to individual three-phase upper-FET gates, and lower gate signals applied to individual three-phase lower-FET gates) which are inputted from the control block 11. In addition, the driver 12 may instead be another IC externally connected to the motor control device 10.

The ADC 13 converts analog current sense signals, which are inputted from the shunt resistor 30, into digital current values (equivalent to current values of the drive currents Iu, Iv and Iw, respectively), outputting the conversion results to the control block 11 and the preprocessing block 15.

The anomaly detection block 14 analyzes input data inputted from the preprocessing block 15 to detect any anomaly of the three-phase motor 20. Input data for the anomaly detection block 14 include information as to the drive currents Iu, lv and Iw and, furthermore in the case of this figure, information as to vibration and temperature of the three-phase motor 20 (or the motor system 1).

Prior to entry of input data into the anomaly detection block 14, the preprocessing block 15 analyzes frequency components of the above-mentioned input data (drive current, vibration and temperature) by subjecting the input data to FFT (Fast Fourier Transform) process Doing such preprocessing allows feature quantities to be extracted from the input data.

### Issues of Comparative Example

The motor system 1 according to the comparative example, as described above, uses the vibration sensor 40 and the temperature sensor 50 to detect anomalies of the three-phase motor 20. However, using a vibration sensor involves various problematic issues.

For example, accurate functioning of the vibration sensor necessitates proper distance-and-location of the vibration sensor from a vibration source. Improper location of the vibration sensor could make it impossible to obtain correct data, leading to erroneous diagnosis or prediction. Also, it is further necessitated to consider an environment under which the vibration sensor is installed. Under severe conditions such as high temperatures, high humidities and dust, there may be influences on the sensor in terms of durability and precision. Therefore, it is desired to check environmental conditions of the installation location and take proper protective measures, beforehand. Furthermore, in installation of the vibration sensor, physical space restrictions also need to be considered Particularly with existing equipment or machinery densely provided, it is difficult to ensure a space for installation of the sensor. These and other issues are similarly involved also with the temperature sensor.

### Embodiment of Present Disclosure

In view of the above-described issues, an embodiment described hereinbelow is carried out.

### <<Motor System>>

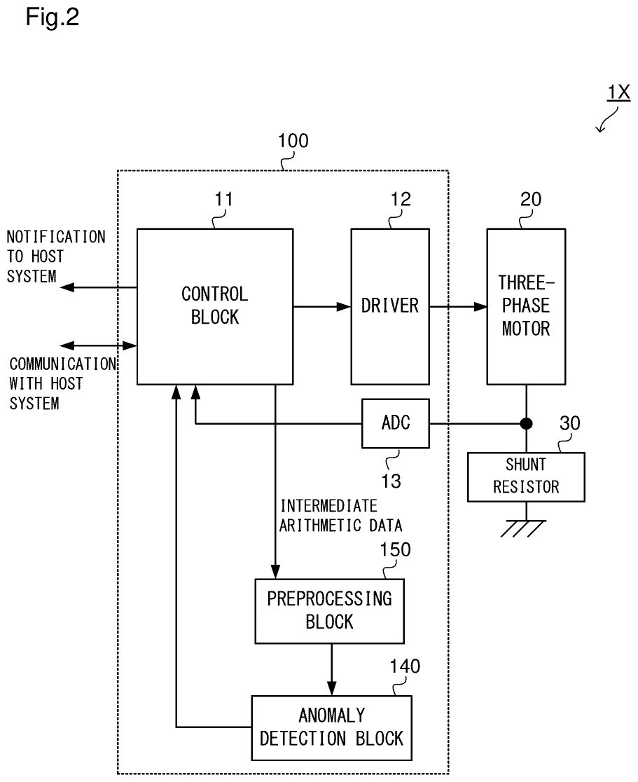

FIG. 2 is a diagram showing a configuration of a motor system 1X according to an embodiment of the present disclosure. The motor system 1X includes a three-phase motor 20, a shunt resistor 30, and a motor control device 100. The three-phase motor 20 and the shunt resistor 30 are similar to those of the above-described comparative example, with their detailed description omitted.

The motor control device 100 is a semiconductor integrated circuit device including a control block 11, a driver 12, an ADC 13, a preprocessing block 150, and an anomaly detection block 140.

The driver 12 and the ADC 13 are similar to those of the foregoing comparative example. The control block 11, as in the foregoing comparative example, accepts input of digital current values (equivalent to current values of the drive currents Iu, lv and Iw, respectively) from the ADC 13. The control block 11 then drives the driver 12 to fulfill feedback control of the drive currents Iu, Iv and Iw flowing in the three-phase motor 20, so that torque and rotational speed of the three-phase motor 20 become equal to target values, respectively. In addition, a concrete configuration example related to motor control by the control block 11 will be described later.

The control block 11 is equipped with a function of dynamically switching its control parameter or control method in response to a detection result of the anomaly detection block 140 a function of notifying a host system of the above-mentioned detection result, and a function of performing communications with the host system.

The preprocessing block 150 executes preprocessing on later-described intermediate arithmetic data inputted from the control block 11. The term, preprocessing, implies FFT process and the like, details of which will be described later.

The anomaly detection block 140 analyzes processed data after execution of the preprocessing in the preprocessing block 150 to fulfill anomaly detection. Details of the anomaly detection block 140 will be described later

### <<Control Block>>

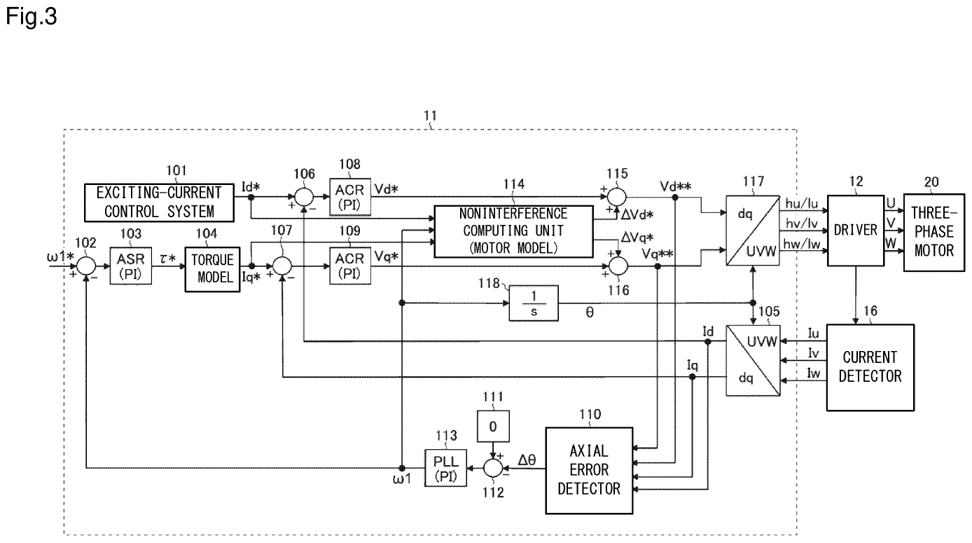

FIG. 3 is a diagram showing a configuration example of the control block 11. The control block 11 shown in FIG. 3 includes an exciting-current regulation system 101, a computing unit 102, an ASR 103, a torque model 104, a three-phase/two-phase converter 105, computing units 106 and 107, ACRs 108 and 109, an axial error detector 110, a lead-angle control value setter 111, a computing unit 112, a PLL controller 113, a noninterference computing unit (motor model) 114, computing units 115 and 116, a two-phase/three-phase converter 117, and a rotor-position detector 118. The control block 11 performs feedback control of the drive currents Iu, Iv and Iw by a three-phase sensorless full-vector control method. In addition, the vector control is referred to also as FOC (Field Oriented Control).

The exciting-current regulation system 101 outputs a d-axis current command Id*.

The computing unit 102 outputs a difference value between an angular velocity command ω1* and an angular velocity ω1.

The ASR 103 (Automatic Speed Regulator) outputs a torque command τ* that allows the angular velocity ω1 to follow the angular velocity command ω1* by PID (Proportional-Integral-Differential) control responsive to an output value (=difference value between an angular velocity command ω1* and an angular velocity ω1) of the computing unit 102. In addition, the ASR 103 may be further equipped with a function of performing arbitrary error control in a case where a state of output values of the computing unit 102 being beyond a specified error-decision threshold has continued over a plurality of cycles.

The torque model 104 converts a torque command τ* into a q-axis current command Iq*.

The three-phase/two-phase converter 105 converts three-phase drive currents Iu, Iv and Iw, which are inputted from a current detector 16, into a two-phase d-axis current Id and a q-axis current Iq by a specified transform algorithm (Clarke transform and Park transform, etc.). In addition, the current detector 16 is equivalent, for example, to the ADC 13 and the shunt resistor 30 of FIG. 2.

The computing unit 106 outputs a difference value between a d-axis current command Id* and a d-axis current Id.

The computing unit 107 outputs a difference value between a q-axis current command Iq* and a q-axis current Iq.

The ACR (Automatic Current Regulator) 108 outputs a d-axis voltage command Vd* that allows the d-axis current Id to follow the d-axis current command Id*, by PID control responsive to an output value (=a difference value between a d-axis current command Id* and a d-axis current Id) of the computing unit 106.

The ACR 109 outputs a q-axis voltage command Vq* that allows the q-axis current Iq to follow the q-axis current command Iq*, by PID control responsive to an output value (=a difference value between a q-axis current command Iq* and a q-axis current Iq) of the computing unit 107.

The axial error detector 110 detects an axial error Δθ from a d-axis current Id and a q-axis current Iq as well as a corrected d-axis voltage command Vd** and a corrected q-axis voltage command Vq** Given a configuration including such an axial error detector 110, the need for an encoder operable to detect the rotor position θ is eliminated, making it feasible to accomplish cost reduction and reliability enhancement of the motor system 1X.

The lead-angle control value setter 111 outputs a specified lead-angle control set value (e.g., zero).

The computing unit 112 outputs a difference value between a specified lead-angle control set value and an axial error Δθ.

The PLL (Phase-Locked Loop) controller 113 outputs an angular velocity ω1 (prediction) that allows the axial error Δθ to be converged to the lead-angle control set value, by PID control responsive to an output value (=a difference value between a specified lead-angle control set value and an axial error Δθ) of the computing unit 112. As a result, control delay or the like can be absorbed. In addition, the control method to be used for the ASR 103, the ACRs 108 and 109, and the PLL controller 113 is not limited to the above-described feedback PID control method, and may be another control method. For example, classical control such as feedforward control or two-degree-of-freedom control may be adopted, or modern control such as adaptive control may also be adopted.

The noninterference computing unit 114 generates a d-axis voltage correction value ΔVd* (=−ω1×Lq*×Iq*) and a q-axis voltage corrected value ΔVq* (=ω1×Ld*×Id*+kE**ω1), by noninterference arithmetic process based on the d-axis current command Id* and the q-axis current command Iq* as well as the angular velocity ω1. In addition, symbols Ld and Lq denote d-axis coil inductance and q-axis coil inductance, respectively, while kE represents counter electromotive force constant.

The computing unit 115 adds together a d-axis voltage command Vd* and a d-axis voltage correction value ΔVd* to output a corrected d-axis voltage command Vd**.

The computing unit 116 adds together a q-axis voltage command Vq* and a q-axis voltage correction value ΔVq* to output a corrected q-axis voltage command Vq**.

By a specified transform algorithm (inverse Park transform and inverse Clarke transform, etc.), the two-phase/three-phase converter 117 converts a two-phase d-axis voltage command Vd** and a q-axis voltage command Vq** into three-phase (six in number in upper-and-lower sum) gate signals hu/Iu, hv/lv and hw/lw to output the result to the driver 12. In addition the two-phase/three-phase converter 117 converts the two-phase d-axis voltage command Vd** and q-axis voltage command Vq** into three-phase voltage commands Vu, Vv and Vw, and then subjects the voltage commands Vu, Vv and Vw to PWM (Pulse Width Modulation) transform to output gate signals hu/Iu, hv/lv and hw/lw.

The rotor-position detector 118 integrates the angular velocity ω1 to detect rotor positions θ, and outputs the results to the three-phase/two-phase converter 105 and the two-phase/three-phase converter 117, respectively.

In addition, the control method of the control block 11 is not limited to the above-described full-vector control method, and may be another vector control method or any other than vector control methods

### <<Intermediate Arithmetic Data>>

In this embodiment, as described in FIG. 2, intermediate arithmetic data outputted from the control block 11 are inputted to the preprocessing block 150. The intermediate arithmetic data are data obtained by arithmetic operations in process in which gate signals hu/Iu, hv/lv and hw/lw (i.e., control output signals) outputted from the control block 11 to the driver 12 are generated based on three-phase drive currents Iu, Iv and Iw (i.e, feedback signals) inputted from the current detector 16 to the control block 11.

Accordingly, in FIG. 3, axial error Δθ, angular velocity ω1, d-axis current Id, q-axis current Iq, and the like are equivalent to the intermediate arithmetic data. These axial error Δθ, angular velocity ω1, d-axis current Id, and q-axis current Iq are control target quantities which are controlled with the lead-angle control set value, the angular velocity command ω1*, the d-axis current command Id*, and the q-axis current command Iq* referenced as their corresponding target values, respectively. In addition to the above-described ones, d-axis voltage command Vd** and q-axis voltage command Vq** as well as voltage commands Vu, Vv and Vw are also equivalent to the intermediate arithmetic data

### <<Preprocessing Block>>

On the intermediate arithmetic data inputted from the control block 11, the preprocessing block 150 executes preprocessing prior to data input into the anomaly detection block 140.

The preprocessing includes the FFT process. Instead, without being limited to the FFT process, for example, frequency analysis process such as wavelet transform may also be used.

Also, the preprocessing may include normalization process. The normalization process is, for example, a process by which data are delimited to a range of about 0 to 1 (or −1 to +1) More specifically, the normalization process is carried out by the following Expression

$$\frac{x - d}{s}$$

where x is input data, and d and s are specified parameters.

Further, the preprocessing may include envelope process.

Further, the preprocessing may include window function process. As the window function process, for example, Hann window, Hamming window, Gaussian window, triangular window, Kaiser window, Chebyshev window, Blackman window, and the like are adoptable.

The above-described preprocessing processes may be executed each singly, or done in plural combinations among those processes. For example, the envelope process may be executed after execution of the normalization process, or the FFT process may be done after execution of the normalization process and a window function process.

As the case may be, intermediate arithmetic data may be inputted to the anomaly detection block 140 without being subjected to the preprocessing.

### <<Anomaly Detection Block>>

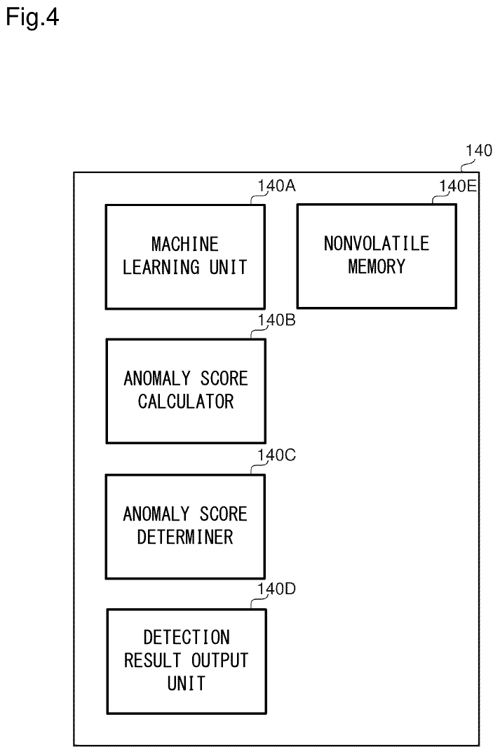

Next, the anomaly detection block 140 will be described in detail. FIG. 4 is a diagram showing a configuration example of the anomaly detection block 140. The anomaly detection block 140 shown in FIG. 4 includes a machine learning unit 140A, an anomaly score calculator 140B, an anomaly score determiner 140C, a detection result output unit 140D, and nonvolatile memory 140E.

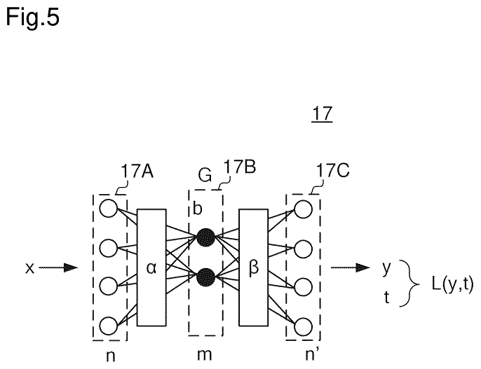

The machine learning unit 140A performs training and prediction for input data (intermediate arithmetic data) As an AI model used in the machine learning unit 140A, for example, such a three-layer neural network 17 as shown in FIG. 5 is used.

As shown in FIG. 5, the three-layer neural network 17 is an AI model including an input layer 17A, a hidden layer 17B, and an output layer 17C. In the three-layer neural network 17, generally, with respect to n-dimensional input data x∈R^{k×n} having a batch size of k, an n′-dimensional prediction result y∈R^{k×n′} can be obtained as y=G (x·a+b)β. In this connection, α∈R^{n×m} is a weight that connects the input layer 17A and the hidden layer 17B to each other, and β∈R^{m×n′} is a weight that connects the hidden layer 17B and the output layer 17C to each other. Also, β∈R^{m} is a bias of the hidden layer 17B, and G is an activation function of the hidden layer 17B.

This embodiment employs an algorithm that allows the three-layer neural network 17 to be trained sequentially on an arbitrary batch-size basis. When ith training data {xᵢ∈R^{ki×n}, tᵢ∈R^{ki×n}} of the batch size kᵢ is obtained, it is necessary to determine βᵢ that minimizes an error represented by Expression (1) below

$$‖ [ \begin{matrix}{H}_{0} \\ ⋮ \\ {H}_{i}\end{matrix} ] {β}_{i} - [ \begin{matrix}{t}_{0} \\ ⋮ \\ {t}_{i}\end{matrix} ] ‖ \qquad ( 1 )$$

It is noted that the ith hidden-layer matrix is Hᵢ=G(xᵢ·α+b) Also, t is teaching data corresponding to a prediction result y.

An optimized weight βᵢ is calculated by Expression (2) below

$${P}_{i} = {P}_{i - 1} - {P}_{i - 1} {{H}_{i}^{T} ( I + {H}_{i} {P}_{i - 1} {H}_{i}^{T} )}^{- 1} {H}_{i} {P}_{i - 1} \qquad ( 2 )$$

$${β}_{i} = {β}_{i - 1} + {P}_{i} {H}_{i}^{T} ( {t}_{i} - {H}_{i} {β}_{i - 1} )$$

Where, P₀ and β₀ are obtained by Expression (3) below

$${P}_{0} = {( {H}_{0}^{T} {H}_{0} )}^{- 1} \qquad ( 3 )$$

$${β}_{0} = {P}_{0} {H}_{0}^{T} {t}_{0}$$

The algorithm of training is as follows
(1) Initialize the values of the weight α and the bias b with random numbers.
(2) Calculate H₀ for x₀, and calculate P₀ and β₀.
(3) Every time the ith training data of batch size k, is obtained, calculate Pᵢ and βᵢ. Here, β₀ need not be calculated according to the equation for its calculation in Expression (3), a value initialized with a random number can be taken as β₀.

Moreover, training using an autoencoder is performed in this embodiment. An autoencoder uses input data as it is as teaching data, and trains in a way that the input data can be reconstructed as a prediction result, that is, in terms of what has been described above, it trains assuming that t=x. An autoencoder does not require separately created teaching data, hence one kind of unsupervised training algorithm.

According to such an AI model in the machine learning unit 140A, training by a computing device of microcomputer-equivalent level is enabled with edge devices. In particular, whereas a complexity-concerned bottleneck in the above Expression (2) is (I+HᵢPᵢ₋₁Hᵢ^{T})⁻¹, the matrix size of (I+HᵢPᵢ₋₁Hᵢ^{T}), being k×k, makes it possible that given k=1, an inverse matrix computation is replaced with a reciprocal computation. Therefore, fixing the batch size at k=1 facilitates the computation under use of computation devices of microcomputer-equivalent level. It is noted that the input data x is time-series data with no FFT process involved in the preprocessing block 150, and frequency-region data with FFT process involved.

In the anomaly score calculator 140B, an anomaly score is calculated by a loss function L(y, t) representing an error between a prediction result y and teaching data t. The loss function employs, for example, MAE (Mean Absolute Error) or MSE (Mean Squared Error). With MAE employed for the loss function, a loss function L is expressed as Expression (4) below

$$L ( y , t ) = \frac{1}{{n}^{′}} \sum \vert y - t \vert \qquad ( 4 )$$

Also, with MSE employed for the loss function, a loss function L is expressed as Expression (5) below

$$L ( y , t ) = \frac{1}{{n}^{′}} \sum {\vert y - t \vert}^{2} \qquad ( 5 )$$

Since the autoencoder is employed to perform training, the anomaly score is calculated as a loss function L(y,t)=L(y,x).

The anomaly score determiner 140C compares a calculated anomaly score with a specified threshold to determine an anomaly level of the anomaly score. Given one threshold, the anomaly level resulting from the determination is either presence or absence of any anomaly Instead, a plurality of thresholds may also be provided. For example, with use of a first threshold and a second threshold (>first threshold), an anomaly score lower than the first threshold results in anomaly level=low, an anomaly score falling within a range from the first threshold to the second threshold results in anomaly level-middle, and an anomaly score higher than the second threshold results in anomaly level-high, and so on.

The detection result output unit 140D outputs an anomaly level determined by the anomaly score determiner 140C to the control block 11.

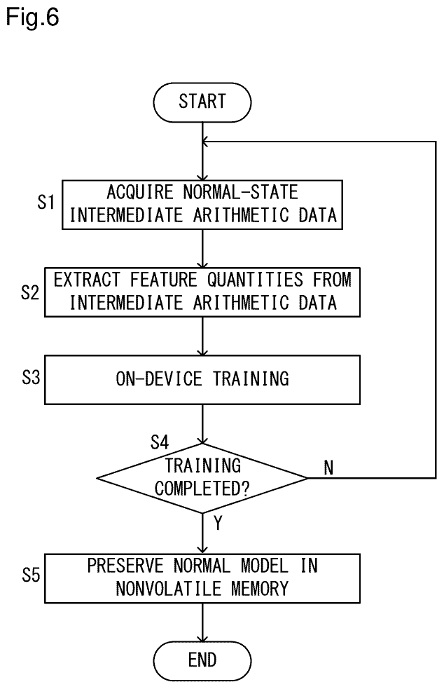

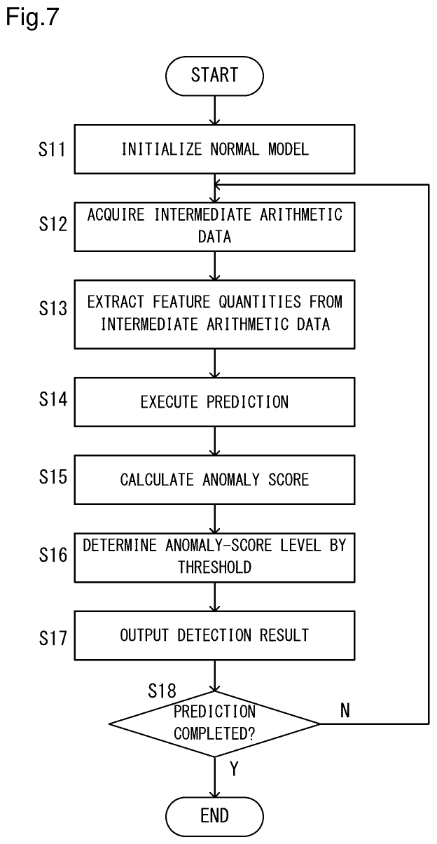

Now, operation examples of the anomaly detection block 140 will be described below with reference to flowcharts shown in FIGS. 6 and 7.

FIG. 6 is a flowchart showing an example of training process operation in the anomaly detection block 140. As the process of FIG. 6 gets started, first at step S1, the preprocessing block 150 acquires intermediate arithmetic data from the control block 11. Then at step S2, the preprocessing block 150 executes preprocessing (FFT process or others) on the acquired intermediate arithmetic data to extract feature quantities.

Next at step S3, the machine learning unit 140A acquires, as input data, data resulting after the preprocessing executed by the preprocessing block 150, and executes training according to the above-mentioned on-device training algorithm. As a result, model parameters of the AI model are updated Given that a condition for ending the training process operation is unsatisfied (N at step S4), the processing returns to step S1. Training process is repeated to update model parameters until the condition for ending the training process operation is satisfied. Given that the condition for ending the training process operation is satisfied (Y at step S4), model parameters are preserved in the nonvolatile memory 140E (step S5) Thus, the processing is completed (end).

FIG. 7 is a flowchart showing an example of prediction process operation in the anomaly detection block 140. First at step S11, the machine learning unit 140A reads model parameters from the nonvolatile memory 140E. As a result, normal-state AI model initialization is fulfilled.

Then at step S12, the preprocessing block 150 acquires intermediate arithmetic data from the control block 11. Then at step S13, the preprocessing block 150 executes preprocessing (FFT process or others) on the acquired intermediate arithmetic data to extract feature quantities.

Next at step S14, the machine learning unit 140A acquires, as input data, data resulting after the preprocessing executed by the preprocessing block 150, and executes prediction process according to the AI model. Then at step S15, the anomaly score calculator 140B calculates an anomaly score on a basis of the prediction result obtained in step S14. Next at step S16, the anomaly score determiner 140C compares a calculated anomaly score with a threshold to determine an anomaly level of the anomaly score. At step S17, the detection result output unit 140D outputs the determined anomaly level.

Then, given that a condition for ending the prediction process operation is unsatisfied (N at step S18), the processing returns to step S12. Prediction process, anomaly calculation, and anomaly level determination are repeated until the condition for ending the prediction process operation is satisfied. Given that the condition for ending the prediction process operation is satisfied (Y at step S18), the processing is completed (end). It is noted that the condition for ending the prediction process operation is, for example, input of a halt command from the user, or a determination result of an “anomaly” as the detection result obtained in step S17, or the like.

The motor system 1X of this embodiment, as described above, eliminates the need for a vibration sensor such as the one added for anomaly detection in the comparative example, so that problems due to equipment of a vibration sensor or the like can be solved. For example, considerations for problems involved in sensor installation as well as for sensor stability are no longer necessitated, so that system maintainability and robustness can be improved. Further, use of intermediate arithmetic data makes it feasible to detect information which is undetectable by ordinary processing of sensor data, hence precision improvement in anomaly detection.

In addition, the machine learning unit 140A may perform training by not only unsupervised techniques but also supervised techniques. Furthermore, without limitation to use of machine learning, the anomaly detection block 140 may detect anomalies by using a rule base. With a rule-based system, for example, it becomes implementable to compare values of a frequency spectrum of specified frequencies in data after FFT process with a specified threshold, or to determine a value outputted after entering input data into a specified function, or the like

### <<Examples of Feature Extraction>>

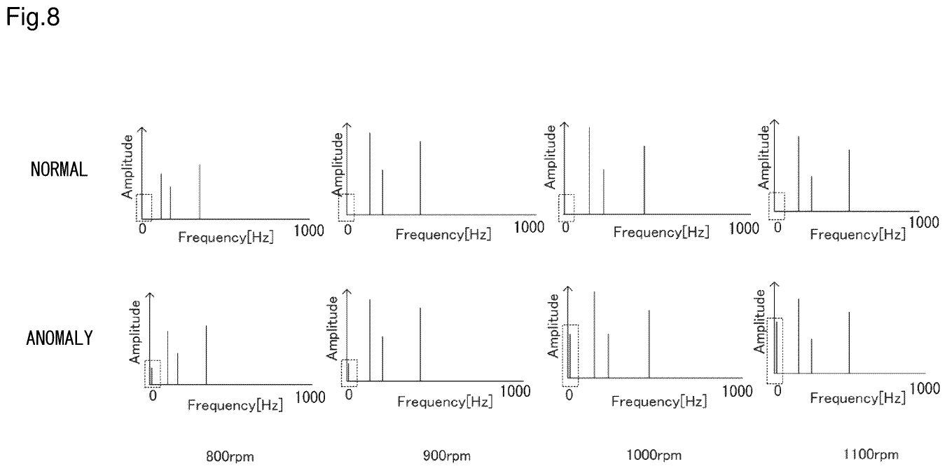

In a circulator as an example of equipment on which a motor is mounted, damage of its fan as a load is one kind of anomaly. In this connection, a weight was fixed on the fan to cause an eccentric state, by which a pseudo anomaly state was created. In such an anomaly state, while rotational speed of the motor was being varied, FFT process of the axial error 40 as an example of the intermediate arithmetic data was executed. FIG. 8 shows results of such FFT process of the axial error 40 under comparisons between normal state and anomaly state. As shown in FIG. 8, three peaks of frequency spectra are ascertained in each of normal state and anomaly state, whereas frequency spectra at low frequencies (framed by broken line) found larger in anomaly state than in normal state.

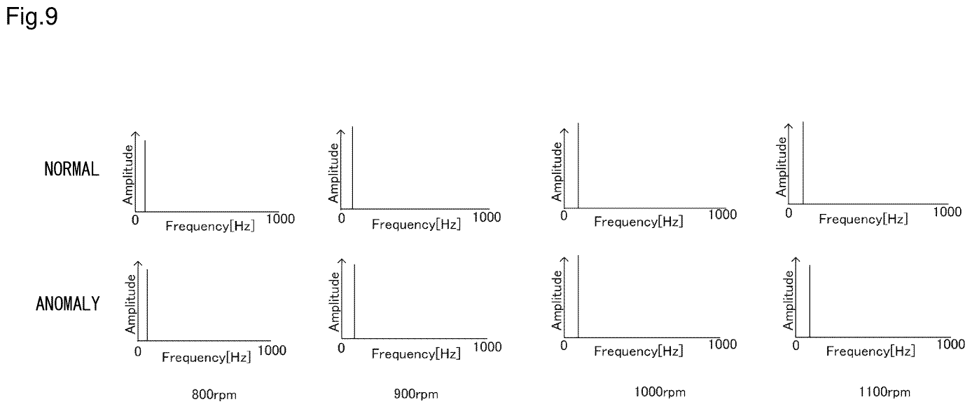

Meanwhile, FIG. 9 shows results of the FFT process of the drive current Iu executed while the rotational speed of the motor was being changed in anomaly states similar to those of the foregoing case, together with results under the normal state. In the case of FIG. 9, as shown above, there cannot be found any significant differences in frequency spectra between normal state and anomaly state. Thus, there are cases where feature quantities that cannot be extracted from drive currents can be extracted with intermediate arithmetic data

### <Others>

In addition, various technical features disclosed herein may be carried out not only as in the above-described embodiment but also as changed or modified without departing from the gist of the technical creation of the disclosure. That is, the embodiment disclosed herein should be construed as not being limitative but being an exemplification at all points. The technical scope of the disclosure is defined not by the above description of the embodiment but by the appended claims, including all changes and modifications equivalent in sense and range to the claims.

### Appendices

As described hereinabove, a control device (100) according to one aspect of the present disclosure comprises
a control block (11) configured to generate, on a basis of feedback signals (Iu, Iv and Iw) derived from an actuator (20), control output signals (hu/Iu, hv/lv and hw/lw) intended for control of the actuator, and
an anomaly detection block (140) configured to detect an anomaly on a basis of intermediate arithmetic data which are generated by computation in a generation process of the control output signal according to the feedback signal in the control block (first configuration).

With such a configuration, anomaly detection is enabled without additionally providing a vibration sensor or the like intended for detection of anomalies.

In the control device of the foregoing first configuration, the actuator may be a motor (second configuration).

Also, in the control device of the foregoing second configuration, the control block may generate the control output signals by a vector control system on a basis of the feedback signals as drive currents of the motor (third configuration).

Also, in the control device of the foregoing third configuration, the intermediate arithmetic data may include at least any one or more of: a d-axis current (Id) and a q-axis current (Iq) generated based on drive currents of the motor by a three-phase/two-phase converter (105), or an axial error (Δθ) generated based on the d-axis current and the q-axis current by an axial error detector (110), or a predicted angular velocity (ω1) generated based on the axial error by a PLL controller (113) (fourth configuration).

Also, in the control device of any one of the foregoing first to fourth configurations, the anomaly detection block (140) may include
a machine learning unit (140A) configured to execute training and prediction upon entry of input data based on the intermediate arithmetic data;
an anomaly score calculator (140B) configured to calculate an anomaly score based on a prediction result obtained by the machine learning unit, and
an anomaly score determiner (140C) configured to determine an anomaly level based on the anomaly score calculated by the anomaly score calculator (fifth configuration).

Also, in the control device of the foregoing fifth configuration, the machine learning unit may execute training and prediction using an autoencoder (sixth configuration).

Also, in the control device of any one of the foregoing first to fourth configurations the anomaly detection block may execute anomaly detection based on a rule base as to data based on the intermediate arithmetic data (seventh configuration).

Also, in the control device of any one of the foregoing first to seventh configurations, the control device may further comprise a preprocessing block configured to execute preprocessing for the intermediate arithmetic data to output preprocessed data to the anomaly detection block (eighth configuration).

Also, in the control device of the foregoing eighth configuration, the preprocessing may include at least any one of normalization, envelope process, frequency analysis process, and window function process (ninth configuration).

Also, an actuator system (1X) anomaly state according to one aspect of the disclosure comprises the control device (100) of any one of the first to ninth configurations, and an actuator (20) controlled by the control device (tenth configuration)

What is claimed is:

1. A control device comprising:
a control block configured to generate, on a basis of feedback signals derived from an actuator, control output signals intended for control of the actuator; and
an anomaly detection block configured to detect an anomaly on a basis of intermediate arithmetic data which are generated by computation in a generation process of the control output signals according to the feedback signals in the control block.

2. The control device as claimed in claim 1, wherein the actuator is a motor.

3. The control device as claimed in claim 2, wherein the control block generates the control output signals by a vector control system according to the feedback signals as drive currents of the motor.

4. The control device as claimed in claim 3, wherein the intermediate arithmetic data include at least any one or more of: a d-axis current and a q-axis current generated based on drive currents of the motor by a three-phase/two-phase converter; or an axial error generated based on the d-axis current and the q-axis current by an axial error detector, or a predicted angular velocity generated based on the axial error by a PLL controller.

5. The control device as claimed in claim 1, wherein
the anomaly detection block includes:
a machine learning unit configured to execute training and prediction upon entry of input data based on the intermediate arithmetic data;
an anomaly score calculator configured to calculate an anomaly score based on a prediction result obtained by the machine learning unit; and
an anomaly score determiner configured to determine an anomaly level based on the anomaly score calculated by the anomaly score calculator.

6. The control device as claimed in claim 5, wherein the machine learning unit executes training and prediction using an autoencoder.

7. The control device as claimed in claim 1, wherein the anomaly detection block executes anomaly detection based on a rule base as to data based on the intermediate arithmetic data.

8. The control device as claimed in claim 1, further comprising a preprocessing block configured to execute preprocessing for the intermediate arithmetic data to output preprocessed data to the anomaly detection block.

9. The control device as claimed in claim 8, wherein the preprocessing includes at least any one of normalization, envelope process, frequency analysis process, and window function process.

10. An actuator system which comprises the control device as claimed in claim 1, and an actuator controlled by the control device.
